(19) United States
(12) Patent Application Publication
(10) Pub. No.: US 2026/0089663 A1
(43) Pub. Date: Mar. 26, 2026

(54) TIME CORRECTION SYSTEM, REFERENCE TIMEPIECE, CORRECTION TARGET TIMEPIECE, TIME CORRECTION METHOD, AND RECORDING MEDIUM

(71) Applicant: CASIO COMPUTER CO., LTD., Tokyo (JP)

(72) Inventors: Hiroyuki FUJIWARA, Tokyo (JP); Daisuke UEMATSU, Tokyo (JP); Kazato NOMURA, Tokyo (JP); Takehiko KII, Tokyo (JP); Takahiro MIZUSHINA, Tokyo (JP)

(21) Appl. No.: 19/336,947

(22) Filed: Sep. 23, 2025

(30) Foreign Application Priority Data
Sep. 24, 2024 (JP) 2024-164750

(51) Int. Cl. H04W 56/00

(52) U.S. Cl. CPC H04W 56/0045; H04W 56/0015

(57) ABSTRACT

A time correction system includes: a reference timepiece counting reference time; and a correction target timepiece correcting time that the correction target timepiece counts, based on the reference time, the reference timepiece transmits information about a scheduled transmission time that is a reference time at which a synchronization signal is scheduled to be transmitted, to the correction target timepiece, and transmits the synchronization signal to the correction target timepiece at a time obtained by subtracting internal delay time occurring inside the reference timepiece from the scheduled transmission time, and the correction target timepiece receives information about the scheduled transmission time, acquires information about external delay time occurring outside the reference timepiece, and corrects time that the correction target timepiece counts in such a way that a time at which the synchronization signal is received coincides with a time obtained by adding the external delay time to the scheduled transmission time.

### CROSS-REFERENCE TO RELATED APPLICATIONS

This application claims the benefit of Japanese Patent Application No. 2024-164750, filed on Sep. 24, 2024, the entire disclosure of which is incorporated by reference herein.

### FIELD OF THE INVENTION

This application relates to a time correction system, a reference timepiece, a correction target timepiece, a time correction method, and a recording medium.

### BACKGROUND OF THE INVENTION

Conventionally, systems that synchronize time among a plurality of communication devices has been known. For example, Patent Literature 1 (Unexamined Japanese Patent Application Publication No. H05-161181) discloses a time synchronization system that takes into account delay time occurring at the time of transmission of a signal between a parent station and a child station.

The above-described time synchronization system includes a delay time calculation circuit 8 that calculates delay time until a signal sent from a parent station a is received by a child station b from signal transmission time and signal reception time, and the child station b matches time of a timepiece 6 of the child station with time of a timepiece 2 of the parent station with the delay time taken into account.

### SUMMARY OF THE INVENTION

One aspect of a time correction system according to the present disclosure includes: a reference timepiece that counts reference time; and a correction target timepiece that corrects time that the correction target timepiece counts, based on the reference time, the reference timepiece executes processing including: transmitting information about a scheduled transmission time, the scheduled transmission time being a reference time at which a synchronization signal is scheduled to be transmitted, to the correction target timepiece; and transmitting the synchronization signal to the correction target timepiece at a time obtained by subtracting internal delay time occurring inside the reference timepiece from the scheduled transmission time, and the correction target timepiece executes processing including: acquiring information about external delay time occurring outside the reference timepiece; and correcting time that the correction target timepiece counts in such a way that a time at which the synchronization signal is received coincides with a time obtained by adding the external delay time to the scheduled transmission time.

### BRIEF DESCRIPTION OF DRAWINGS

A more complete understanding of this application can be obtained when the following detailed description is considered in conjunction with the following drawings, in which:

FIG. 1 is a block diagram illustrating a functional configuration of a time correction system according to an embodiment;

FIG. 2 is an example of a flowchart of time information transmission processing and time information reception processing in a case where a reference timepiece and a correction target timepiece are directly connected;

FIG. 3 is an example of a flowchart of time information transmission processing and time information reception processing in a case where the reference timepiece and the correction target timepiece are connected by a communication cable;

FIG. 4 is an example of a flowchart of time information transmission processing and time information reception processing in a case where the reference timepiece and the correction target timepiece are communicable using radio waves; and

FIG. 5 is a diagram for a description of more precise propagation delay time.

### DETAILED DESCRIPTION OF THE INVENTION

A time correction system and the like according to an embodiment is described with reference to the drawings. Note that the same or equivalent constituent components are designated by the same reference numerals in the drawings.

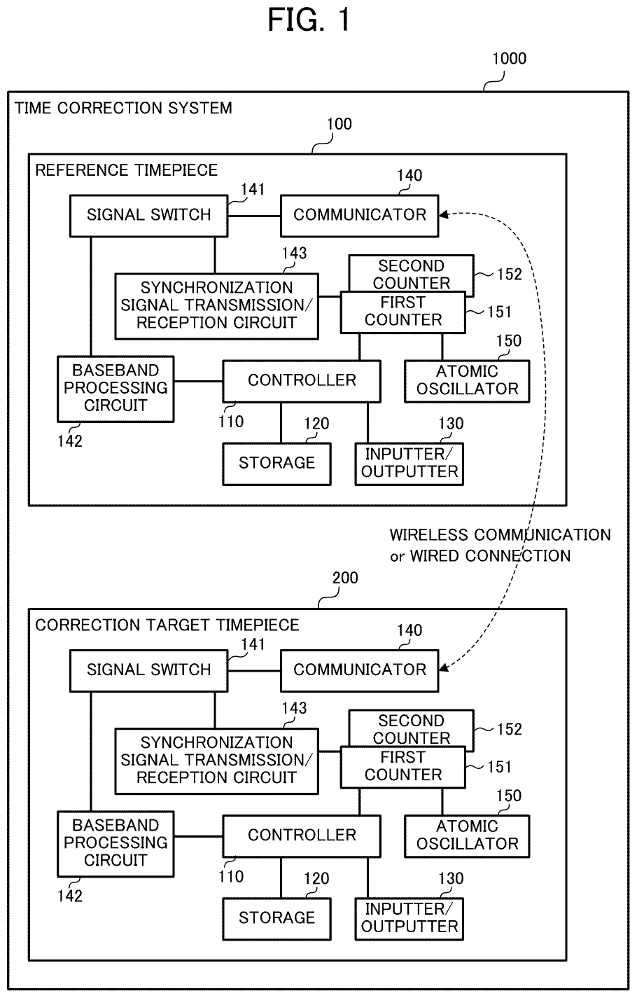

A time correction system 1000 according to the embodiment is a system that includes, as illustrated in FIG. 1, a reference timepiece 100 and a correction target timepiece 200 and that corrects time that the correction target timepiece 200 counts, based on time that the reference timepiece 100 counts. The reference timepiece 100 may be either a watch, such as a wristwatch or a clock, such as a desk clock. Furthermore, the correction target timepiece 200 may be either a watch, such as a wristwatch or a clock, such as a desk clock.

In addition, as illustrated in FIG. 1, functional configurations of the reference timepiece 100 and the correction target timepiece 200 are the same, and both the reference timepiece 100 and the correction target timepiece 200 include a controller 110, a storage 120, an inputter/outputter 130, a communicator 140, a signal switch 141, a baseband processing circuit 142, a synchronization signal transmission/reception circuit 143, an atomic oscillator 150, a first counter 151, and a second counter 152.

In addition, when it is desired to distinguish the constituent components of the reference timepiece 100 and the constituent components of the correction target timepiece 200 from each other, terms “reference” and “target” are added to names of the constituent components in the reference timepiece 100 and the constituent components in the correction target timepiece 200, respectively. For example, the synchronization signal transmission/reception circuit 143 of the reference timepiece 100 is also referred to as a reference synchronization signal transmission/reception circuit, and the synchronization signal transmission/reception circuit 143 of the correction target timepiece 200 is also referred to as a target synchronization signal transmission/reception circuit. In addition, the counters 151 and 152 of the reference timepiece 100 are also referred to as reference counters, and the counters 151 and 152 of the correction target timepiece 200 are also referred to as target counters.

The controller 110 includes at least one processor, such as a central processing unit (CPU), and a real time clock (RTC). The processor operates in synchronization with a clock of the RTC. The controller 110 executes processing to achieve various functions of each of the reference timepiece 100 and the correction target timepiece 200 and time information transmission processing and time information reception processing, which are described later, by a program stored in the corresponding storage 120. Note that the controllers 110 supports multi-thread processing and can execute a plurality of processes in parallel.

The storage 120 stores programs that the controller 110 executes and required data. The storage 120 includes a memory, such as a random access memory (RAM) and a read only memory (ROM). In addition, in the storage 120, delay time required for transmission from an internal time information source (the first counter 151 or the second counter 152) to a communication connector (a communication connector of the communicator 140) is stored in advance as internal delay time in transmission, and delay time required for reception from the communication connector (the communication connector of the communicator 140) to the internal time information source (the first counter 151 or the second counter 152) is stored in advance as internal delay time in reception. However, since the internal delay time in transmission and the internal delay time in reception often become the same time, in such a case, only one value may be stored and used in a shared manner for both the internal delay time in transmission and the internal delay time in reception. In addition, hereinafter, the internal delay time in transmission stored in the storage 120 of the reference timepiece 100 is also referred to as reference internal delay time, and the internal delay time in reception stored in the storage 120 of the correction target timepiece 200 is also referred to as target internal delay time.

The inputter/outputter 130 includes an outputter and an operation inputter. The outputter includes a display, such as a liquid crystal display and an organic EL display, and displays, for example, time. In addition, the operation inputter includes a user interface, such as a slide switch and a push-button switch, and accepts operation input from a user.

The communicator 140 includes a device for the reference timepiece 100 and the correction target timepiece 200 to perform data communication with each other and perform transmission and reception of a pulse signal and a communication antenna for wireless communication. Although the communicators 140 are capable of performing communication through both wired communication and wireless communication, the wired communication includes two types of communication, namely direct connection communication in which communication is performed by directly connecting communication connectors and cable communication in which communication is performed by connecting communication connectors with a communication cable. In the communication cable used for performing the cable communication, an integrated circuit (IC) into which information about delay time due to propagation in the communication cable is written is incorporated, and the controller 110 of the correction target timepiece 200 to which the communication cable is connected can acquire the information about cable delay time from the communication cable at an arbitrary timing.

In addition, signals communicated between the communicators 140 include two types of signals, namely a binary data signal exchanged in data communication between the controllers 110 of the reference timepiece 100 and the correction target timepiece 200 and a pulse signal for exchanging timing without involving the controllers 110. The signal switch 141 is a switch for switching which of the above-described signals to be communicated, and the switching is performed by the controller 110 in advance. In addition, the signal switch 141 is also capable of switching whether the above-described signals are communicated by wired communication (connecting to the communication connector) or wireless communication (connecting to RF circuit and the antenna).

The baseband processing circuit 142 is a circuit that demodulates binary data signal and thereby enables the controller 110 to acquire the binary data signal as binary data.

The synchronization signal transmission/reception circuits 143 includes a circuit (synchronization signal reception circuit) to directly input a single pulse signal for notifying timing to counters (the first counter 151 and the second counter 152), which are described later, and a circuit (synchronization signal transmission circuit) to output a single pulse signal to the communicator 140 via the signal switch 141 in synchronization with counting in the counters. Note that the synchronization signal transmission/reception circuit 143 as described above can be easily achieved by a programmable logic device (PLD), such as a field-programmable gate array (FPGA).

The atomic oscillator 150 is a reference signal source made of an atomic clock and is a highly accurate oscillator with only an error of 10-10 or less.

The first counter 151 of the reference timepiece 100 functions as a timepiece that maintains accurate time, based on oscillation of the atomic oscillator 150. In other words, the first counter 151 of the reference timepiece 100 counts reference time. Note that in the correction target timepiece 200, although the atomic oscillator 150 oscillates accurate timing, the first counter 151 of the correction target timepiece 200 does not necessarily count accurate time.

The second counter 152 functions as a timer that can keep accurate time, based on the oscillation of the atomic oscillator 150.

The counters 151 and 152 can be caused to start and stop counting by a pulse signal received by the synchronization signal transmission/reception circuit 143, at a timing of the pulse signal. In addition, a pulse signal can be transmitted from the synchronization signal transmission/reception circuit 143 in synchronization with counting and the start and stop of counting in the counters 151 and 152.

The functional configurations of the reference timepiece 100 and the correction target timepiece 200 are described above. Next, processing of correcting time that the correction target timepiece 200 counts (time that the first counter 151 of the correction target timepiece 200 counts), based on time that the reference timepiece 100 counts (the reference time that the first counter 151 of the reference timepiece 100 counts) is described with respect to three types of connections (direct connection, cable connection, and radio wave connection).

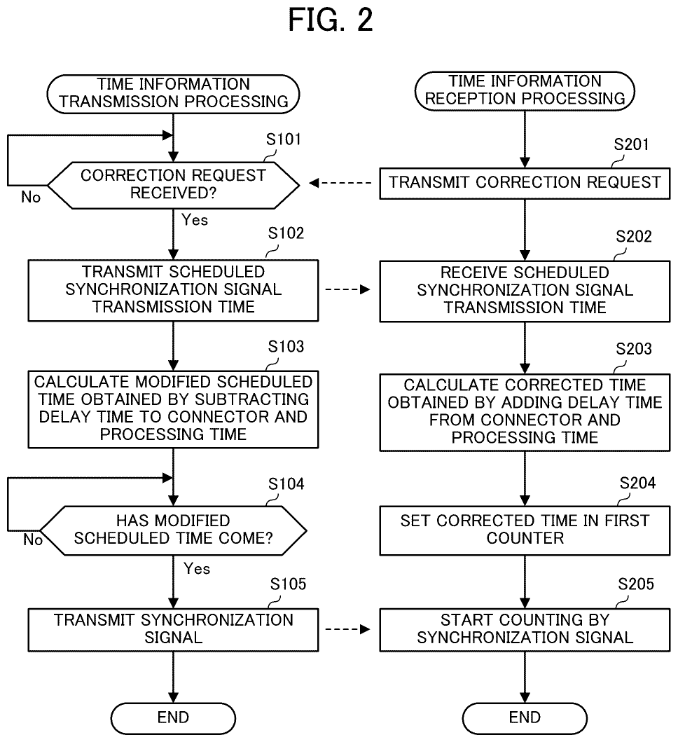

First, processing of correcting time by directly connecting the reference timepiece 100 and the correction target timepiece 200 (time information transmission processing in the reference timepiece 100 and time information reception processing in the correction target timepiece 200) is described with reference to FIG. 2.

First, the time information transmission processing that the controller 110 of the reference timepiece 100 executes is described with reference to the left-hand side of FIG. 2. When the reference timepiece 100 is powered on, the controller 110 of the reference timepiece 100 starts execution of the time information transmission processing in conjunction with other required processing.

First, the controller 110 of the reference timepiece 100 sets the signal switch 141 to connect the communication connector of the communicator 140 to the baseband processing circuit 142, and determines whether or not the reference timepiece 100 has received a correction request from the correction target timepiece 200 via the communication connector of the communicator 140 (step S101). The correction request is packet data that the correction target timepiece 200 transmits to the reference timepiece 100 when the correction target timepiece 200 makes a correction to time.

When the reference timepiece 100 has not received a correction request (step S101; No), the controller 110 of the reference timepiece 100 returns to step S101 and waits until the reference timepiece 100 receives a correction request.

When the reference timepiece 100 receives a correction request (step S101; Yes), the controller 110 of the reference timepiece 100 transmits information about a scheduled synchronization signal transmission time to the correction target timepiece 200 via the communication connector of communicator 140 (step S102). The scheduled synchronization signal transmission time is a reference time of the reference timepiece 100 (a time that the first counter 151 counts) at a timing at which a synchronization signal used to correct the time of the correction target timepiece 200 is transmitted. It is configured such that transmitting information about the reference time at this timing in advance makes transmission of time information unnecessary when transmitting a synchronization signal and enables the synchronization signal to be transmitted by a pulse signal that notifies only timing. Note that although the scheduled synchronization signal transmission time can be set to any time as long as the time is at and after a time obtained by adding processing time required to transmit the synchronization signal to a current time, a time several seconds after the current time (for example, after one second) may be simply set as the scheduled synchronization signal transmission time.

Next, the controller 110 of the reference timepiece 100 calculates a modified scheduled time by subtracting the reference internal delay time, which is stored in the storage 120, and the processing time required to transmit the synchronization signal from the scheduled synchronization signal transmission time (step S103). Note that since a sum of the reference internal delay time and the processing time required to transmit the synchronization signal is delay time occurring inside the reference timepiece 100, the reference internal delay time and the processing time are also collectively referred to as internal delay time. The controller 110 of the reference timepiece 100 sets the signal switch 141 to connect the communication connector of the communicator 140 to the synchronization signal transmission/reception circuit 143.

Next, the controller 110 of the reference timepiece 100 reads the first counter 151 and determines whether or not the modified scheduled time has come (step S104).

When the modified scheduled time has not come (step S104; No), the controller 110 returns to step S104 and wait until the modified scheduled time.

When the modified scheduled time comes (step S104; Yes), the synchronization signal transmission/reception circuit 143 of the reference timepiece 100 outputs a synchronization signal at that timing, and the synchronization signal is transmitted from the communication connector of the communicator 140 (step S105). Note that although the synchronization signal is a single pulse signal, the signal is referred to as a synchronization signal since the synchronization signal is a signal to make a correction to time of a correction target timepiece (to make the time of the correction target timepiece synchronized with the reference timepiece). Consequently, the time information transmission processing terminates.

Since as described above, in the time information transmission processing, a time obtained by subtracting the reference internal delay time and the processing time required to transmit the synchronization signal from the scheduled synchronization signal transmission time is calculated as a modified scheduled time and transmission of the synchronization signal is started at the time, the synchronization signal is caused to reach the communication connector at the timing of the scheduled synchronization signal transmission time, and influence of delay time occurring in the reference timepiece 100 can thus be eliminated.

Next, the time information reception processing that the controller 110 of the correction target timepiece 200 executes is described with reference to the right-hand side of FIG. 2. When the correction target timepiece 200 is to make a correction to time, the correction target timepiece 200 may start execution of the time information reception processing at an arbitrary timing. For example, the correction target timepiece 200 may start the execution of the time information reception processing, based on an instruction from the user, or may start the execution of the time information reception processing periodically (for example, once a year).

First, the controller 110 of the correction target timepiece 200 sets the signal switch 141 to connect the communication connector of the communicator 140 to the baseband processing circuit 142, and transmits a correction request to the reference timepiece 100 via the communication connector of the communicator 140 (step S201).

Next, the controller 110 of the correction target timepiece 200 receives the information about the scheduled synchronization signal transmission time transmitted by the reference timepiece 100, via the communication connector of the communicator 140 (step S202). Although not illustrated in FIG. 2 to avoid the flow from being complicated, the controller 110 of the correction target timepiece 200 waits in step S202 in practice until receiving the information about the scheduled synchronization signal transmission time.

Next, the controller 110 of the correction target timepiece 200 calculates a corrected time obtained by adding the target internal delay time, which is stored in the storage 120, and processing time required to receive a synchronization signal to the scheduled synchronization signal transmission time (step S203). Note that since a sum of the target internal delay time and the processing time required to receive a synchronization signal is delay time occurring outside the reference timepiece 100, the target internal delay time and the processing time are also collectively referred to as external delay time. Next, the controller 110 of the correction target timepiece 200 sets the corrected time in the first counter 151 (step S204), and sets the signal switch 141 to connect the communication connector of the communicator 140 to the synchronization signal transmission/reception circuit 143.

Next, the synchronization signal transmission/reception circuit 143 of the correction target timepiece 200, by directly inputting the synchronization signal transmitted by the reference timepiece 100 to the first counter 151, causes the first counter 151 to start counting at a timing of receiving the synchronization signal (step S205), and terminates the time information reception processing.

In the conventional clock synchronization system, although delay time that occurs at the time of transmitting a signal between a parent station and a child station is taken into consideration, delay times inside the parent station and the child station are not taken into consideration. Although in a case of a general clock with high accuracy (for example, approximately one second per month), such delay time inside a circuit is not particularly a problem, in the case of a clock with extremely high precision (for example, one second in 3000 years) such as an atomic clock, the delay time becomes a problem.

In contrast, in the time information reception processing of the time correction system in the present disclosure, since a time obtained by adding the target internal delay time and the processing time required to receive a synchronization signal to the scheduled synchronization signal transmission time is calculated as a corrected time, and a correction is made to the clock (the first counter 151) of the correction target timepiece 200 at the corrected time, influence of delay time occurring inside the correction target timepiece 200 (external to the reference timepiece 100) can be eliminated.

The time information transmission processing and the time information reception processing in the case where the communication connector of the reference timepiece 100 and the communication connector of the correction target timepiece 200 are directly connected are described above.

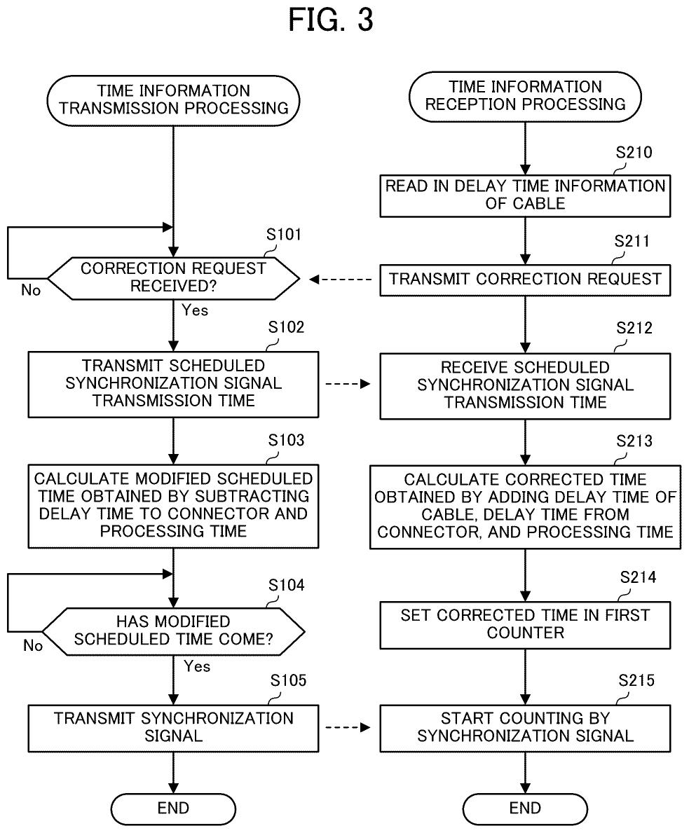

Next, time information transmission processing and time information reception processing in the case where the communication connector of the reference timepiece 100 and the communication connector of the correction target timepiece 200 are connected by a communication cable is described with reference to FIG. 3.

However, since in the case of cable connection, the time information transmission processing executed by the controller 110 of the reference timepiece 100 is the same processing as the time information transmission processing in the case of direct connection described with reference to the left-hand side of FIG. 2, a description thereof is omitted.

The time information reception processing that the controller 110 of the correction target timepiece 200 executes in the case of cable connection is described with reference to the right-hand side of FIG. 3. When the correction target timepiece 200 is to make a correction to time, the correction target timepiece 200 may start execution of the time information reception processing at an arbitrary timing after the communication connector of the correction target timepiece 200 and the communication connector of the reference timepiece 100 are connected to each other by a dedicated communication cable. For example, the correction target timepiece 200 may start the execution of the time information reception processing, based on an instruction from the user, or may start the execution of the time information reception processing periodically (for example, once a year).

First, the controller 110 of the correction target timepiece 200 sets the signal switch 141 to connect the communication connector of the communicator 140 to the baseband processing circuit 142, and reads in information about cable delay time from the IC incorporated in the communication cable (step S210).

Since processing in the next steps S211 and S212 is the same as the processing in steps S201 and S202 in the time information reception processing in the case of direct connection, which is described with reference to the right-hand side of FIG. 2, a description thereof is omitted.

In step S213, the controller 110 of the correction target timepiece 200 calculates a corrected time obtained by adding the cable delay time read in in step S210, the target internal delay time, which is stored in the storage 120, and the processing time required to receive a synchronization signal to the scheduled synchronization signal transmission time (step S213).

Since processing in the next steps S214 and S215 is the same as the processing in steps S204 and S205 in the time information reception processing in the case of direct connection, which is described with reference to the right-hand side of FIG. 2, a description thereof is omitted.

As described above, in the time information reception processing, since a time obtained by adding the cable delay time, the target internal delay time, and the processing time required to receive a synchronization signal to the scheduled synchronization signal transmission time is calculated as a corrected time, and a correction is made to the clock (the first counter 151) of the correction target timepiece 200 at the corrected time, influence of delay time occurring inside the communication cable and the correction target timepiece 200 (external to the reference timepiece 100) can be eliminated.

The time information transmission processing and the time information reception processing in the case where the communication connector of the reference timepiece 100 and the communication connector of the correction target timepiece 200 are connected by the communication cable are described above.

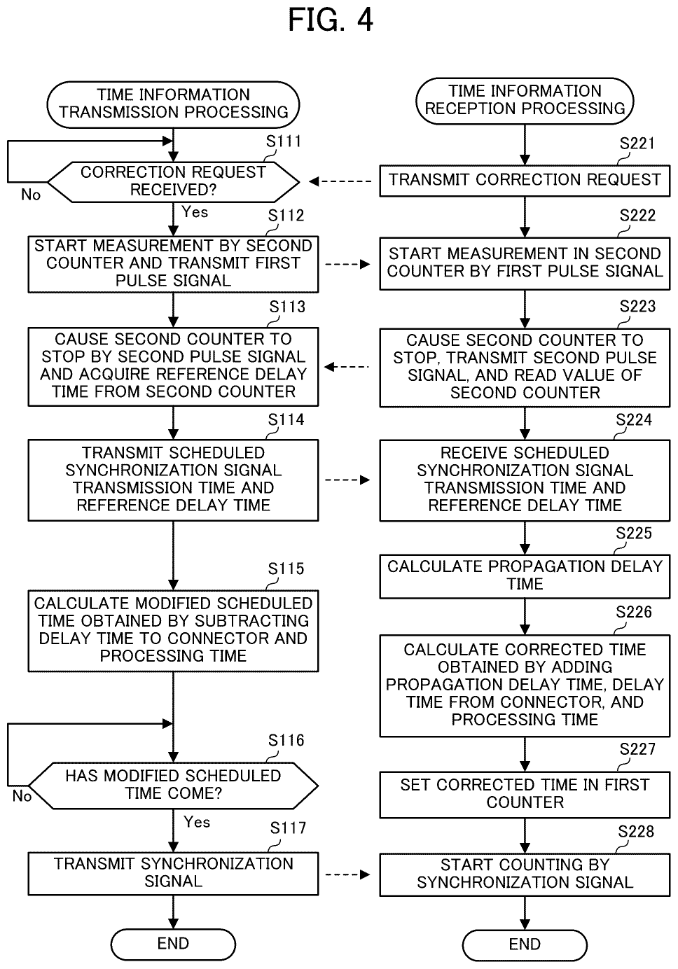

Next, time information transmission processing and time information reception processing in the case where the reference timepiece 100 and the correction target timepiece 200 communicate with each other using radio waves is described with reference to FIG. 4.

First, the time information transmission processing that the controller 110 of the reference timepiece 100 executes is described with reference to the left-hand side of FIG. 4. When the reference timepiece 100 is powered on, the controller 110 of the reference timepiece 100 starts execution of the time information transmission processing in conjunction with other required processing.

First, the controller 110 of the reference timepiece 100 sets the signal switch 141 to connect the antenna of the communicator 140 to the baseband processing circuit 142, and determines whether or not the reference timepiece 100 has received a correction request from the correction target timepiece 200 via the antenna of the communicator 140 (step S111).

When the reference timepiece 100 has not received a correction request (step S111; No), the controller 110 of the reference timepiece 100 returns to step S111 and waits until the reference timepiece 100 receives a correction request.

When the reference timepiece 100 receives a correction request (step S111; Yes), the controller 110 of the reference timepiece 100 sets the signal switch 141 to connect the antenna of the communicator 140 to the synchronization signal transmission/reception circuit 143, starts counting (time measurement) by the second counter 152, and transmits a pulse signal (first pulse signal) that is output from the synchronization signal transmission/reception circuit 143 to the correction target timepiece 200, using the antenna of the communicator 140 in synchronization with the counting (step S112).

Next, the reference timepiece 100 directly inputs a pulse signal (second pulse signal) transmitted from the correction target timepiece 200 to the second counter 152 through the synchronization signal transmission/reception circuit 143, causes the second counter 152 to stop counting at a timing of the second pulse signal, reads a value counted by the second counter 152, and acquires the value as a reference delay time (step S113).

Next, the controller 110 of the reference timepiece 100 sets the signal switch 141 to connect the antenna of the communicator 140 to the baseband processing circuit 142, and transmits information including the scheduled synchronization signal transmission time and the reference delay time acquired in step S113 to the correction target timepiece 200 (step S114).

Since processing in the next steps S115 to S117 is the same as the processing in steps S103 to S105 in the time information transmission processing in the case of direct connection, which is described with reference to the left-hand side of FIG. 2, a description thereof is omitted.

Next, the time information reception processing executed by the controller 110 of the correction target timepiece 200 in the case where the reference timepiece 100 and the correction target timepiece 200 communicate with each other using radio waves is described with reference to the right-hand side of FIG. 4. When the correction target timepiece 200, which is capable of communicating with the reference timepiece 100, using radio waves, is to make a correction to time, the correction target timepiece 200 may start execution of the time information reception processing at an arbitrary timing. For example, the correction target timepiece 200 may start the execution of the time information reception processing, based on an instruction from the user, or may automatically start the execution of the time information reception processing periodically (for example, once a year).

First, the controller 110 of the correction target timepiece 200 sets the signal switch 141 to connect the antenna of the communicator 140 to the baseband processing circuit 142, and transmits a correction request to the reference timepiece 100 via the antenna of the communicator 140 (step S221).

Next, the controller 110 of the correction target timepiece 200 directly inputs the pulse signal (first pulse signal) transmitted by the reference timepiece 100 to the second counter 152 through the synchronization signal transmission/reception circuit 143, and starts counting (time measurement) by the second counter 152 at a timing of the first pulse signal (step S222). Next, the controller 110 of the correction target timepiece 200 causes the second counter 152 to stop counting, transmits a pulse signal (second pulse signal) output from the synchronization signal transmission/reception circuit 143 to the reference timepiece 100 via the antenna of the communicator 140 in synchronization with the stopping of the counting by the second counter 152, reads a value counted by the suspended second counter 152, and acquires the value as a target delay time (step S223).

Next, the controller 110 of the reference timepiece 200 sets the signal switch 141 to connect the antenna and the RF circuit of the communicator 140 to the baseband processing circuit 142, and receives the information including the scheduled synchronization signal transmission time and the reference delay time transmitted by the reference timepiece 100 via the communicator 140 (step S224). Next, the controller 110 of the correction target timepiece 200 calculates propagation delay time, based on the reference delay time and the target delay time (step S225). The propagation delay time can simply be calculated by the following mathematical expression (1):

$$( 1 )$$

$$( propagation delay time ) = ( ( reference delay time ) - ( target delay time ) ) / 2$$

Note, however, that since in the mathematical expression (1), delay times inside the reference timepiece 100 and the correction target timepiece 200 are not taken into consideration, there is a possibility that the propagation delay time includes a slight error. More precise propagation delay time is described later.

Next, the controller 110 of the correction target timepiece 200 calculates a corrected time obtained by adding the target internal delay time, which is stored in the storage 120, and processing time required to receive a synchronization signal to the scheduled synchronization signal transmission time (step S226). Next, the controller 110 of the correction target timepiece 200 sets the corrected time in the first counter 151 (step S227), and sets the signal switch 141 to connect the RF circuit and antenna of the communicator 140 to the synchronization signal transmission/reception circuit 143.

Next, the synchronization signal transmission/reception circuit 143 of the correction target timepiece 200, by directly inputting the synchronization signal transmitted by the reference timepiece 100 to the first counter 151, causes the first counter 151 to start counting at a timing of receiving the synchronization signal (step S228), and terminates the time information reception processing.

As described above, in the time information reception processing, since a time obtained by adding the propagation delay time, the target internal delay time, and the processing time required to receive a synchronization signal to the scheduled synchronization signal transmission time is calculated as a corrected time, and a correction is made to the clock (the first counter 151) of the correction target timepiece 200 at the corrected time, influence of delay time occurring in radio wave propagation and inside the correction target timepiece 200 (external to the reference timepiece 100) can be eliminated.

The time information transmission processing and the time information reception processing in the case where the reference timepiece 100 and the correction target timepiece 200 can communicate with each other using radio waves is described above.

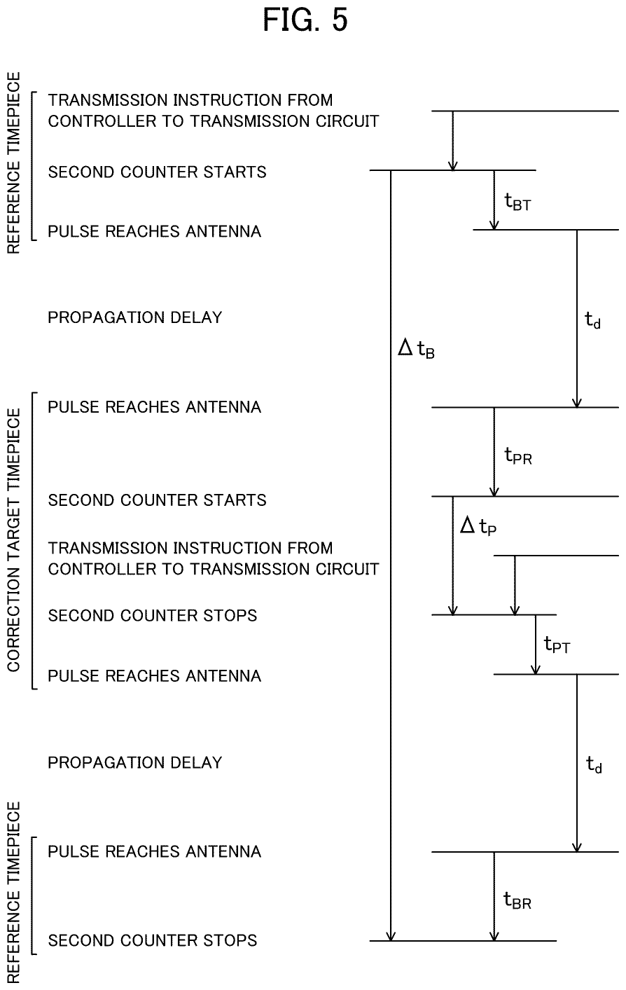

Next, more precise propagation delay time is described with reference to FIG. 5. Note that in order to simplify description, the following variables are introduced with respect to periods of time and time points relating to the reference timepiece 100 and the correction target timepiece 200.

Variables relating to the reference timepiece 100:
tBT: a period of time from when the second counter 152 starts or stops counting until a pulse reaches the antenna (that is, internal delay time in transmission);
tBR: a period of time from when a pulse reaches the antenna until the second counter 152 starts or stops counting (that is, internal delay time in reception); and
ΔtB: a period of time from when the second counter 152 starts counting until the second counter 152 stops counting (that is, reference delay time).

Variables relating to the correction target timepiece 200:
tPR: a period of time from when a pulse reaches the antenna until the second counter 152 starts or stops counting (that is, internal delay time in reception);
tPT: a period of time from when the second counter 152 starts or stops counting until a pulse reaches the antenna (that is, internal delay time in transmission); and
ΔtP: a period of time from when the second counter 152 starts counting until the second counter 152 stops counting (that is, target delay time).

First, in step S112 in FIG. 4, a transmission instruction of a pulse signal is output from the controller 110 to the synchronization signal transmission/reception circuit 143, and counting by the second counter 152 is started. Next, it takes the time tBT for the pulse signal to reach the antenna, subsequently the pulse signal is transmitted from the antenna, and, after the propagation delay time td, the pulse signal reaches the antenna of the correction target timepiece 200.

In the correction target timepiece 200, it takes the time tPR for the pulse signal to reach the second counter 152 from the antenna, and counting by the second counter 152 is started in step S222 in FIG. 4. Next, in step S223, a transmission instruction of a pulse signal is output from the controller 110 of the correction target timepiece 200 to the synchronization signal transmission/reception circuit 143, and the second counter 152 is caused to stop counting. Next, it takes the time tPT for the pulse signal to reach the antenna, subsequently the pulse signal is transmitted from the antenna, and, after the propagation delay time td, the pulse signal reaches the antenna of the reference timepiece 100.

In the reference timepiece 100, it takes the time tBR for the pulse signal to reach the second counter 152 from the antenna.

From the above description and FIG. 5, it is revealed that the following mathematical expression (2) holds between the reference delay time ΔtB counted by the second counter 152 of the reference timepiece 100 and the target delay time ΔtP counted by the second counter 152 of the correction target timepiece 200:

$$Δ tB = tBT + td + tPR + Δ tP + tPT + td + tBR . \qquad ( 2 )$$

Therefore, the propagation delay time td can be expressed by the following mathematical expression (3):

$$td = ( Δ tB - Δ tP - tBT - tBR - tPT - tPR ) / 2. \qquad ( 3 )$$

Note that tBT and tBR are the internal delay time in transmission and the internal delay time in reception stored in the storage 120 of the reference timepiece 100, respectively and tPT and tPR are the internal delay time in transmission and the internal delay time in reception stored in the storage 120 of the correction target timepiece 200, respectively. Therefore, in order to determine more precise propagation delay time using the mathematical expression (3), the correction target timepiece 200 is required to acquire tBT and tBR in advance (by, for example, the reference timepiece 100 transmitting tBT and tBR between steps S111 and S112 and the correction target timepiece 200 receiving tBT and tBR between steps S221 and S222).

As described in the foregoing, in the time correction system 1000, since the reference timepiece 100, after transmitting information about a time at which a synchronization signal is scheduled to be transmitted (the scheduled synchronization signal transmission time) to the correction target timepiece 200 in advance, transmits the synchronization signal to the correction target timepiece 200 at a time obtained by subtracting the internal delay time occurring inside the reference timepiece 100 from the scheduled synchronization signal transmission time, the reference timepiece 100 can transmit the synchronization signal to the correction target timepiece 200 at an accurate timing without being influenced by the delay time occurring inside the reference timepiece 100.

In addition, since the correction target timepiece 200 includes the synchronization signal transmission/reception circuit 143 that is capable of directly inputting a synchronization signal (pulse signal) to the counters 151 and 152, the correction target timepiece 200 can make a correction to the clock with high precision without depending on clock speed of the controller 110.

In addition, since the correction target timepiece 200 acquires information about the external delay time occurring outside the reference timepiece 100 and corrects time that the first counter 151 is counting in such a way that a time at which a synchronization signal is received coincides with a time obtained by adding the external delay time to the scheduled synchronization signal transmission time, the correction target timepiece 200 can correct time that the correction target timepiece 200 counts at an accurate timing without being influenced by the delay time occurring outside the reference timepiece 100.

In addition, by exchanging the first pulse signal and the second pulse signal, the reference timepiece 100 and the correction target timepiece 200 can acquire information about more precise external delay time.

Although in the above-described embodiment, for facilitating understanding, the reference timepiece 100 and the correction target timepiece 200 are described separately, both are communication devices of the same configuration, in practice. Therefore, in a case where there are two identical timepieces, as long as the above-described processing is executed assuming that the timepiece that counts time serving as a reference time at the time of time correction is the reference timepiece 100 and the timepiece that is to be corrected is the correction target timepiece 200, either one of the timepieces may be defined as the reference timepiece 100 or the correction target timepiece 200.

In the above-described embodiment, the description is made under the assumption that programs for various types of processing executed by the controller 110 (such as the time information transmission processing and the time information reception processing) are stored in advance in the storage 120. However, a computer that is capable of executing the above-described processing may be configured by storing and distributing the programs in a non-transitory computer-readable recording media, such as a flexible disk, a compact disc read only memory (CD-ROM), a digital versatile disc (DVD), a magneto-optical disc (MO), a memory card, and a USB memory, and reading in and installing the programs into the computer.

Further, the programs can be superimposed on a carrier wave and applied via a communication medium, such as the Internet. For example, the programs may be posted on a bulletin board system (BBS) on a communication network and distributed via the communication network. It may be configured such that by starting and executing the program under the control of the operating system (OS) in a similar manner to other application programs, the processing described above can be executed.

In addition, the controller 110 may be configured not only by an arbitrary processor, such as a single processor, multiple processors, and a multi-core processor, alone but also by one or more such arbitrary processors, or may be configured by combining one or more such arbitrary processors and one or more processing circuits, such as an application specific integrated circuit (ASIC) and an FPGA.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A time correction system, comprising:
a reference timepiece that counts reference time; and a correction target timepiece that corrects time that the correction target timepiece counts, based on the reference time,
wherein the reference timepiece executes processing including:
transmitting information about a scheduled transmission time, the scheduled transmission time being a reference time at which a synchronization signal is scheduled to be transmitted, to the correction target timepiece; and
transmitting the synchronization signal to the correction target timepiece at a time obtained by subtracting internal delay time occurring inside the reference timepiece from the scheduled transmission time, and
the correction target timepiece executes processing including:
receiving information about the scheduled transmission time;
acquiring information about external delay time occurring outside the reference timepiece; and
correcting time that the correction target timepiece counts in such a way that a time at which the synchronization signal is received coincides with a time obtained by adding the external delay time to the scheduled transmission time.

2. The time correction system according to claim 1,
wherein the correction target timepiece
includes a target synchronization signal transmission/reception circuit that has a function of directly inputting the synchronization signal transmitted by the reference timepiece to a target counter by which the correction target timepiece counts time, and
receives the synchronization signal by the target synchronization signal transmission/reception circuit and causes the target counter to start counting.

3. The time correction system according to claim 2,
wherein the reference timepiece includes
a reference synchronization signal transmission/reception circuit that has a function of outputting a first pulse signal and the synchronization signal in synchronization with counting of a reference counter by which the reference timepiece counts time and a function of directly inputting a second pulse signal transmitted by the correction target timepiece to the reference counter,
the target synchronization signal transmission/reception circuit further has a function of directly inputting the first pulse signal transmitted by the reference timepiece to the target counter and a function of outputting the second pulse signal in synchronization with counting of the target counter,
the reference timepiece transmits information about reference delay time, the reference delay time being time from when the first pulse is transmitted until the second pulse is received, to the correction target timepiece, and
the correction target timepiece acquires information about the external delay time, based on the reference delay time.

4. A reference timepiece executing processing comprising:
counting reference time;
transmitting information about a scheduled transmission time, the scheduled transmission time being the reference time at which a synchronization signal is scheduled to be transmitted, to a correction target timepiece; and
transmitting the synchronization signal to the correction target timepiece at a time obtained by subtracting internal delay time occurring internally from the scheduled transmission time.

5. A correction target timepiece executing processing comprising:
receiving information about a scheduled transmission time transmitted by a reference timepiece;
acquiring information about external delay time occurring outside the reference timepiece; and
correcting time that the correction target timepiece counts in such a way that a time at which a synchronization signal transmitted by the reference timepiece is received coincides with a time obtained by adding the external delay time to the scheduled transmission time.

6. A time correction method for correcting time that a correction target timepiece counts, based on reference time that a reference timepiece counts, the time correction method comprising
the reference timepiece:
transmitting information about a scheduled transmission time, the scheduled transmission time being a reference time at which a synchronization signal is scheduled to be transmitted, to the correction target timepiece; and
transmitting the synchronization signal to the correction target timepiece at a time obtained by subtracting internal delay time occurring inside the reference timepiece from the scheduled transmission time, and
the correction target timepiece:
receiving information about the scheduled transmission time;
acquiring information about external delay time occurring outside the reference timepiece; and
correcting time that the correction target timepiece counts in such a way that a time at which the synchronization signal is received coincides with a time obtained by adding the external delay time to the scheduled transmission time.

7. The time correction method according to claim 6,
wherein the correction target timepiece
includes a target synchronization signal transmission/reception circuit that has a function of directly inputting the synchronization signal transmitted by the reference timepiece to a target counter by which the correction target timepiece counts time, and
receives the synchronization signal by the target synchronization signal transmission/reception circuit and causes the target counter to start counting.

8. The time correction method according to claim 7,
wherein the reference timepiece includes
a reference synchronization signal transmission/reception circuit that has a function of outputting a first pulse signal and the synchronization signal in synchronization with counting of a reference counter by which the reference timepiece counts time and a function of directly inputting a second pulse signal transmitted by the correction target timepiece to the reference counter,
the target synchronization signal transmission/reception circuit further has a function of directly inputting the first pulse signal transmitted by the reference timepiece to the target counter and a function of outputting the second pulse signal in synchronization with counting of the target counter,
the reference timepiece transmits information about reference delay time, the reference delay time being time from when the first pulse is transmitted until the second pulse is received, to the correction target timepiece, and
the correction target timepiece acquires information about the external delay time, based on the reference delay time.

9. A non-transitory computer-readable recording medium storing a program causing a controller of a reference timepiece that counts reference time to execute processing comprising:
transmitting information about a scheduled transmission time, the scheduled transmission time being the reference time at which a synchronization signal is scheduled to be transmitted, to a correction target timepiece; and
transmitting the synchronization signal to the correction target timepiece at a time obtained by subtracting internal delay time occurring internally from the scheduled transmission time.

10. A non-transitory computer-readable recording medium storing a program causing a controller of a correction target timepiece to execute processing comprising:
receiving information about a scheduled transmission time transmitted by a reference timepiece;
acquiring information about external delay time occurring outside the reference timepiece; and
correcting time that the correction target timepiece counts in such a way that a time at which a synchronization signal transmitted by the reference timepiece is received coincides with a time obtained by adding the external delay time to the scheduled transmission time.
